(19) United States
(12) Patent Application Publication
(10) Pub. No.: US 2009/0029100 A1
(43) Pub. Date: Jan. 29, 2009

(54) METHOD FOR PRODUCING RIGID LAMINATES FOR OPTICAL APPLICATIONS

(75) Inventors: Robert Michael WIGDORSKI, Red Lion, PA (US); Kevin James McKINNEY, Seven Valleys, PA (US)

Correspondence Address: MCNEES WALLACE & NURICK LLC, 100 PINE STREET, P.O. BOX 1166, HARRISBURG, PA, 17108-1166, US

(73) Assignee: ADHESIVES RESEARCH, INC., Glen Rock, PA (US)

(21) Appl. No.: 11/781,354

(22) Filed: Jul. 23, 2007

(51) Int. Cl. B32B 7/04; B29C 65/54; B30B 7/02

(52) U.S. Cl. 428/98; 156/273.3; 156/295; 156/583.1

(57) ABSTRACT

A method for fabricating a rigid lamination. The method includes providing a first rigid substrate, disposing an adhesive on a surface of the first rigid substrate and disposing a second rigid substrate on at least a portion of the adhesive. The second rigid substrate has a first end and a second end. The second rigid substrate is heated to a substantially uniform temperature, where the temperature is sufficient to melt the adhesive. A non-uniform pressure is applied to a surface of the second rigid substrate. The non-uniform pressure includes a lesser pressure and a greater pressure, where the greater pressure is applied at the first end of the second rigid substrate and is sufficient to impart adhesive flow in a direction toward the second end. The pressure is controllably increased along at least a portion of the surface between the first end and the second end, where the increase is controlled to drive the adhesive flow in the direction toward the second end until the pressure applied is substantially uniform across the surface and the adhesive between the first rigid substrate and the second rigid substrate is substantially free of entrained gas bubbles. The adhesive is cooled to form a rigid lamination having adhesive substantially free of entrained gas bubbles.

### FIELD OF THE INVENTION

The present disclosure is directed to rigid laminate materials. In particular, the present disclosure is directed to rigid laminate materials for use in optical devices.

### BACKGROUND OF THE INVENTION

Methods for producing optical laminations are known. However, each of the known methods requires a reasonable degree of sophistication to insure that the visual quality of the laminations is maintained. The degree of sophistication required with each method varies with the substrates being combined and becomes increasingly more demanding as one progresses from laminations involving flexible substrate to flexible substrate combinations, to laminations involving flexible substrate to rigid substrate combinations, to laminations involving rigid substrate to rigid substrate combinations, and finally, to laminations involving rigid substrate to rigid substrate combinations that require a cavity between the substrates to be filled with optical quality material. The degree of sophistication required is also dependent on the bonding media used to combine the substrates.

Many adhesives have been used to produce optical quality laminations, ranging from liquids to non-tacky adhesive films. However, there has always been a desire to produce these laminations with tacky pressure sensitive adhesive films, due to the inherent ability of these adhesives to bond quickly and hold substrates together without fixtures.

Formation of optical quality rigid to rigid bonds using pressure sensitive adhesive films is known, and in all cases, sophisticated means (e.g., complicated and expensive vacuum environments) to eliminate defects caused by air entrapment between the adhesive surface and the rigid surfaces to which they are being bonded has been employed. In a typical assembly operation, the initial lamination to the base or bottom substrate needs to be defect free. The initial lamination is followed by positioning the top substrate above the adhesive layer, which layer is supported on removable or retractable tabs or pins. Once positioned, a vacuum is drawn to evacuate air from between the top substrate and the adhesive layer. Attachment of the top substrate to the adhesive is accomplished by retraction of the tabs holding the top substrate away from the adhesive, followed by pressing the top substrate onto the adhesive surface. In some cases, center point pressure is applied to the top substrate in an attempt to bow the top substrate slightly, with the intent to improve the chances of producing a defect free lamination. The equipment used provide precise surface alignment of the substrates, totally exclude air prior to the lamination being made and employ significant electronic interlocks to insure all operations are carried out in a specific sequence. The equipment designed for these applications is very expensive. Apparatus of this type is described in U.S. Pat. No. 5,592,288, which is herein incorporated by reference in its entirety. In addition to the equipment requirements, the pressure sensitive adhesive films used for these applications must be manufactured to tightly tolerance thickness profiles. This dimensional accuracy is necessary to minimize stresses that would be encountered between the rigid substrates and the adhesive layers, leading to delamination defects as the laminated structures age or are subjected to severe changes in environmental conditions. The pressure sensitive adhesive films used for these applications are typically pre-cured to provide for enhanced environmental stability once the assemblies are prepared. It is additionally required that these tacky pressure sensitive films must be produced without defects such as air bubbles, as the defects would be observed in the laminated structures when the adhesive films are used to produce devices that require optical quality laminations.

The difficulties encountered with this process become increasingly more challenging when cavities need to be filled between the base and top rigid surfaces. In these cases, not only is precise lamination of multiple adhesive layers typically required to fill in the cavity between the two rigid surfaces, defect free lamination within the confines of the raised perimeter is also extremely difficult to accomplish. An example of such an application would be the production of ruggedized or toughened displays, such as toughened notebook computers or displays, post-modified for avionic, defense or extreme environment applications.

Although these types of applications are serviced using liquid and film based adhesives, it is impractical from a cost standpoint to use the current techniques for large scale manufacturing for many potential applications. It would therefore be desirable to have an inexpensive, easy method to affix rigid surfaces to the face of a display to produce toughened displays for general use.

What is needed is a method and apparatus that can produce substantially bubble free laminations, including rigid substrate to rigid substrate laminations as well as rigid substrate to rigid substrate laminations having a cavity disposed therebetween. What is further needed is a method and apparatus that provides for inexpensive manufacture, i.e., does not required complicated and/or expensive equipment and/or fabrication techniques.

### SUMMARY OF THE INVENTION

A method for producing optical grade lamination of two rigid substrates utilizing tacky hot melt adhesive films is provided. The method eliminates the need for highly sophisticated combining equipment typically used for rigid-to-rigid substrate bonding. Further the method permits the ability to fill a cavity with optical quality adhesive and combine two rigid substrates without visual defects when the rigid substrates are separated, such as that found when a perimeter step or bezel surrounds the perimeter of one or more of the rigid substrates being combined.

One aspect of the present disclosure includes a method for fabricating a rigid lamination. The method includes providing a first rigid substrate, disposing an adhesive on a surface of the first rigid substrate and disposing a second rigid substrate on at least a portion of the adhesive. The second rigid substrate has a first end and a second end. The second rigid substrate is heated to a substantially uniform temperature, where the temperature is sufficient to melt the adhesive. A non-uniform pressure is applied to a surface of the second rigid substrate. The non-uniform pressure includes a lesser pressure and a greater pressure, where the greater pressure is applied at the first end of the second rigid substrate and is sufficient to impart adhesive flow in a direction toward the second end. The pressure is controllably increased along at least a portion of the surface between the first end and the second end, where the increase is controlled to drive the adhesive flow in the direction toward the second end until the pressure applied is substantially uniform across the surface and the adhesive between the first rigid substrate and the second rigid substrate is substantially free of entrained gas bubbles. The adhesive is cooled to form a rigid lamination having adhesive substantially free of entrained gas bubbles.

Another aspect of the present disclosure includes an apparatus for forming a rigid lamination. The apparatus includes a first platen arranged and disposed to receive a lamination assembly, where the lamination includes a plurality of rigid substrates with an adhesive disposed between at least two of the rigid substrates. A second platen is operably disposed with respect to the first platen in order to apply a force and apply heat to the lamination assembly. The second platen is configured to heat a surface of the lamination assembly to a substantially uniform temperature, where the temperature being sufficient to melt the adhesive and to apply a non-uniform pressure to the surface of the lamination assembly. The non-uniform pressure includes a lesser pressure and a greater pressure, where the greater pressure is applied to a first end of the surface and being sufficient to impart adhesive flow in a direction toward a second end. The second platen is further capable of controllably increasing the pressure along at least a portion of the surface between the first end and the second end, where the increase is controlled to continue adhesive flow in the direction toward the second end until the pressure applied is substantially uniform across the surface.

Another aspect of the present disclosure includes rigid lamination having a first rigid substrate with an adhesive disposed on at least a portion of the surface of the first rigid substrate. A second rigid substrate is in contact with the adhesive. The adhesive includes a first portion and a second portion, where the first portion is substantially free of entrained bubbles of gas and the second portion is removable and includes entrained bubbles of gas.

Embodiments of the present disclosure provide easy, forgiving methods for preparing rigid substrate to rigid substrate bonds for optical applications, including applications where cavity fill is required.

Embodiments of the present disclosure include substantially bubble-free laminations that can be easily prepared, bonding rigid substrates together and also producing substantially bubble-free laminations when rigid substrates need to be adhered where center cavities need to be filled therebetween.

In addition, embodiments of the present disclosure, which include adhesive systems having resistance to environmental extremes normally associated with toughened displays, can be produced that function with this methodology. Further, the adhesive films utilized in this process do not require special thickness control, nor do the films need to be prepared bubble free. Additionally, if gas becomes entrapped between multiple layers of adhesive or at the interface between the adhesive and the rigid substrate during initial positioning of the various layers, the gas bubbles may be expelled by pressing the rigid substrates together according to the method of the present disclosure.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 illustrates an exploded perspective view of a lamination assembly according to an embodiment of the present disclosure.

FIG. 2 illustrates an exploded perspective view of a lamination assembly according to another embodiment of the present disclosure.

FIG. 3 illustrates a cross-sectional view of a laminate according to an embodiment of the present disclosure.

FIGS. 4-6 illustrates cross-sectional views of a lamination assembly during a method according to an embodiment of the present disclosure.

FIG. 7 illustrates a top view of a lamination assembly after application of heat and pressure according to an embodiment of the present disclosure.

FIGS. 8-11 illustrates elevational side views of an apparatus during a method according to an embodiment of the present disclosure.

Wherever possible, the same reference numbers will be used throughout the drawings to refer to the same or like parts.

### DETAILED DESCRIPTION OF THE INVENTION

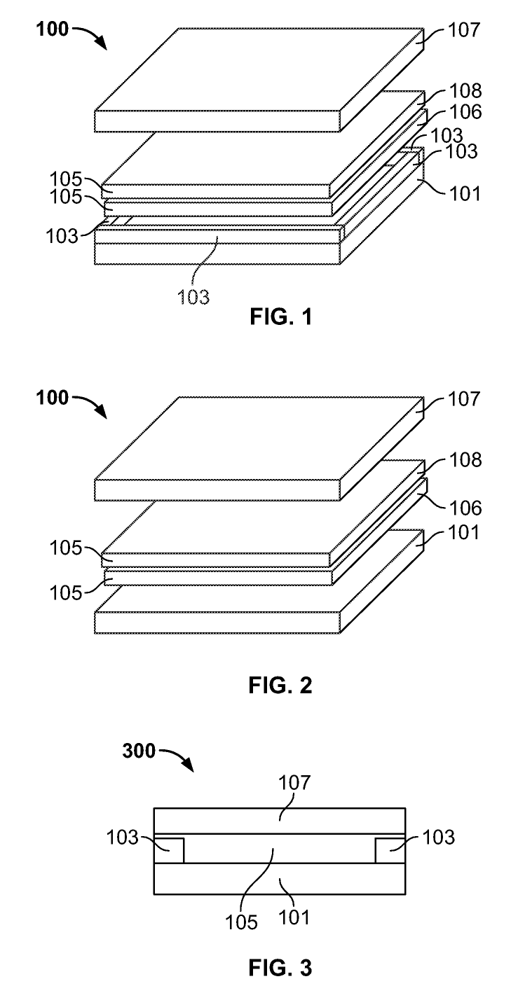

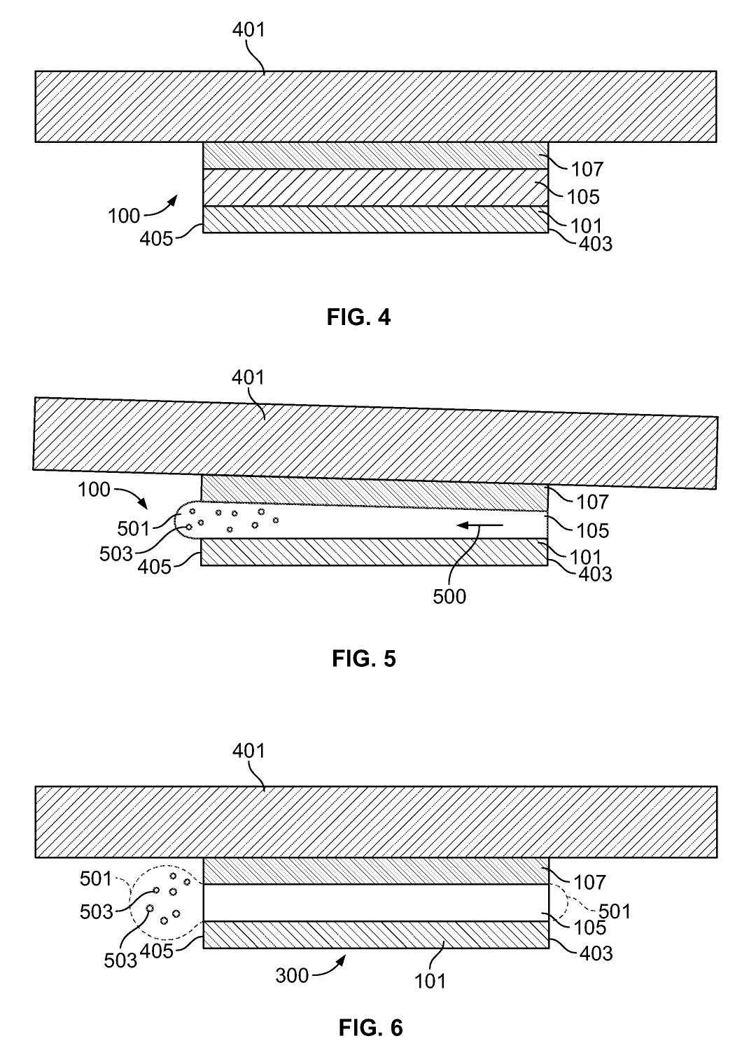

FIG. 1 illustrates a lamination assembly 100 according to an embodiment of the present disclosure. Lamination assembly 100 includes a first rigid substrate 101. The first rigid substrate 101 is substantially rigid and has sufficient stiffness to resist deflection during application of pressure by a platen 401 or other heated structure (see e.g., FIG. 4). A perimeter step 103 is disposed on the first rigid substrate 101. The perimeter step 103 is a barrier or similar structure fabricated from a metallic foil or other material to contain an adhesive layer 105. For example, the perimeter step 103 may be a perimeter bezel for use on a visual display, including a protective cover or casing surrounding the display wherein the face of the display screen is open to view. Suitable materials for use for the perimeter step 103 include, but are not limited to, metal or metal alloys, such as stainless steel. However other heat and impact resistant materials such as molded plastics that would serve to protect the perimeter of the display may be utilized in the perimeter step 103.

Adhesive layer 105 includes one or more layers of adhesive disposed on the surface of the first rigid substrate 101. Although the adhesive layer 105 is shown as two layers, including a first adhesive layer 106 and a second adhesive layer 108, the adhesive layer 105 may be a single layer or more than two layers, as desired for the particular lamination assembly 100. As shown first adhesive layer 106 is configured to fill the cavity formed by the perimeter step 103. Second adhesive layer 108 overlies the first adhesive layer 106 and provides additional material, preferably, but not necessarily, the same material as the first adhesive layer 106. Second adhesive layer 108 is preferably hot melt, heat flowable material. Adhesive layer 105 may include, but is not limited to hot melt adhesive, pressure sensitive adhesive or other adhesive suitable for affixing rigid substrates together. Other suitable adhesives include hot melt adhesive compositions, including photocurable hot melt adhesive compositions or other hot melt adhesive compositions. The adhesives are preferably tacky and provide at least some adherence at room temperature. Other adhesives may include ionomeric adhesive compositions or any other composition that include a melt viscosity sufficiently high to permit the formation of a material flow and removal of entrained gas bubbles. Adhesive layer 105 may be applied utilizing any known application techniques suitable for use with adhesive compositions. The adhesive may be applied in the solid form, wherein the adhesive becomes liquid upon heating above the melting point of the adhesive. In addition, pre-coated adhesive transfer tapes may be conveniently used for application of the adhesive layer 105. In addition, adhesive layer 105 may include more than one adhesive incorporated therein. In one embodiment of the present disclosure, the adhesive layer 105 may include a pressure sensitive adhesive layer disposed on the first rigid substrate 101 to facilitate release of one or both of the first rigid substrate 101 and the second rigid substrate 107 upon application of force and/or heat.

The volume of the adhesive in the adhesive layer 105 applied to the first rigid substrate 101 is greater than the volume of the desired layer for the lamination (see e.g., FIG. 3). For example, in FIG. 1, the perimeter step 103 bounds a preselected volume between the first rigid substrate 101 and the second rigid substrate 107. The adhesive material provided in the first adhesive layer 106 and the second adhesive layer 108 preferably includes at least twice the volume bound by the perimeter step 103, as shown in FIG. 3. The additional volume utilized is preferably provided by the second adhesive layer 108. The total volume of adhesive is sufficient to provide a material flow during processing sufficient to remove bubbles of gas from the adhesive layer 105. In addition to sufficient volume, the adhesive in the adhesive layer 105 is configured to have a viscosity suitable for forming the material flow desired for removal of gas bubbles from the adhesive layer. Suitable viscosity includes, but is not limited to, a viscosity of greater than about 37,500 centipoise (cP) or greater than about 50,000 cP at temperatures equal to or greater than the melting point of the adhesive. The second rigid substrate 107 is substantially rigid and has sufficient structural stiffness to resist deflection during application of pressure by a platen 401 (see e.g., FIG. 4). Each of first rigid substrate 101, adhesive layer 107 and second rigid substrate 107, individually, include optical properties including, but not limited to, the property of being, transparent, translucent, refractory or otherwise light transmissive or distributive.

FIG. 2 illustrates a lamination assembly 100 according to another embodiment of the present disclosure. Lamination assembly 100 includes a first rigid substrate 101, a second rigid substrate 107 and an adhesive layer 105 interposed therebetween. The adhesive layer 105 includes a first adhesive layer 106 and a second adhesive layer 108, which may be the same adhesive composition or different adhesive compositions.

FIG. 3 shows a lamination 300 formed by the method of the present disclosure. Lamination 300 includes a first rigid substrate 101, an adhesive layer 105 bounded by perimeter step 103, and a second rigid substrate in contact with the adhesive layer 105. The adhesive layer 105 in lamination 300 is substantially free of entrained gas bubbles. In addition, adhesive layer 105 is preferably a cured material wherein the layer 105 is set via cooling and cured by exposure to light. The cured adhesive layer 105 is preferably resistant to heat substantially above the initial melting point of the uncured adhesive layer such that the adhesive will withstand environmental extremes associated with the end use for the finished product. Suitable adhesives for use in the adhesive layer 105 can be formulated to use alternate cure mechanisms such as thermal exposure, microwave radiation exposure, electron beam exposure or radio frequency exposure. Alternate cure mechanisms are particularly suitable if the rigid substrate application/device where the lamination 300 being produced is to be installed is configured for operation within these cure conditions. The method could also be used to produce non-transparent or semi-transparent laminations if these alternate cure mechanisms were to be used.

In one embodiment of the present disclosure, the lamination 300 includes an optically transparent first rigid substrate 101, an optically transparent adhesive layer 105 and an optically transparent second rigid substrate 107.

FIG. 4 shows a lamination assembly prior to processing according to the method of an embodiment of the present disclosure. The lamination assembly 100 is placed into contact with or otherwise disposed adjacent to a platen 401. As discussed above, the lamination assembly 100 includes a first rigid substrate 101, a second rigid substrate 107 and an adhesive layer 105 disposed therebetween. The adhesive layer 105 may include gas bubbles, such as air present in the adhesive or entrained therein from the assembly of the components. In addition, the entrained gas bubbles are not limited to air and may include gasses or vapor present in the environment therein trapped during adhesive processing or lamination assembly. Platen 401 includes a metallic or other heat resistant rigid material capable of providing selective heat and pressure to the lamination assembly 100. To produce a lamination 300, platen 401 provides substantially uniform heat to the second rigid substrate 107. Pressure or force is applied by the platen 401. The pressure is initially non-uniform, wherein the pressure is a first magnitude or a greater pressure at a first end 403 of the lamination assembly 100 and a second magnitude or a lesser pressure at a second end 405 of the lamination assembly. The first magnitude is greater than the second magnitude.

As shown in FIG. 5, as the adhesive is heated and reaches the melting point temperature of the adhesive, the second rigid substrate 107 moves in response to the greater pressure at the first end 403 in a direction toward first rigid substrate 101 into and displacing a portion of the adhesive layer 105. As the second rigid substrate 107 displaces the adhesive layer 105, a material flow 500 is created in a direction toward the second end 405. The material flow carries adhesive material and entrained gas bubbles across the lamination assembly 100 and exits the lamination assembly 100 as excess adhesive 501. Entrained gas bubbles 503 present in the adhesive layer are carried with the material flow 500. The pressure applied by the platen 401 is increased across the second rigid substrate 107 until the pressure provided by the platen 401 is substantially uniform across the second rigid substrate 107. In one embodiment, the pressure is applied with the greater pressure at the first end 403 of the second rigid substrate 107 and the pressure along the surface toward the second end 405 is increased at a substantially constant rate until a substantially uniform pressure is applied along the surface of the second rigid substrate 107.

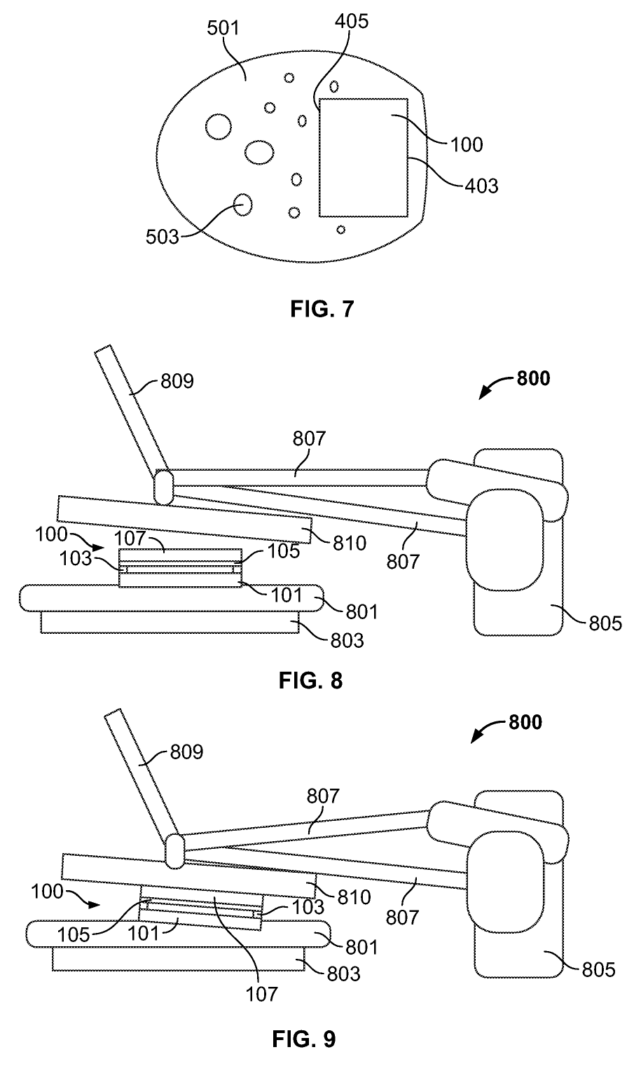

As shown in FIG. 6, the resultant lamination 300, after cooling includes a first rigid substrate 101 adhered to a second rigid substrate 107 by an adhesive layer 105 substantially devoid of entrained gas bubbles 503. As shown, excess adhesive 501 including entrained gas bubbles 503 is removed by cutting, scraping or other suitable technique. While not so limited, in certain embodiments, the adhesive utilized in the adhesive layer 105 may include a photocurable adhesive. In these embodiments, the lamination 300 may be exposed to ultraviolet radiation wavelengths (UV) or other electromagnetic energy source to cure the adhesive within adhesive layer 105. As shown in FIG. 6, the excess adhesive 501 may be expelled in all directions (see also FIG. 7), wherein the excess adhesive 501 may escape from the first end 403 as well as the second end 405 of the lamination assembly 100 or between the edges bridging ends 403, 405.

FIG. 7 shows a top view of the lamination assembly processed according to a method of the present disclosure. The excess adhesive 501 escapes from the lamination assembly 100 in all directions, wherein the majority of the material is rejected from the second end 405 of the lamination assembly. While it is permittable for some excess adhesive 501 to be expelled in each direction, it is preferable that most or all of the excess adhesive 501, including entrained gas bubbles 503, be driven by material flow 500 from the lamination assembly 100 from the second end 405 forming lamination 300 upon cooling.

FIG. 8 shows an apparatus 800 according to an embodiment of the present disclosure prior to applying pressure and/or heat to a lamination assembly 100. A lamination assembly 100 is disposed on a first platen 801, which is disposed on a support 803. The first platen 801 is preferably a foam or other elastically deformable material, capable of yielding in response to applied force. Apparatus 800 includes a base 805 having arms 807 extending therefrom. A control lever 809 is rotatably connected to arms 807 and actuates a second platen 810 and provides control of the pressure applied. Second platen 810 is heatable and movable, for example, rotatable and/or pivotable, such that application of pressure on the lamination assembly 100. As discussed above with respect to platen 401, second platen 810 includes a metallic or other heat resistant rigid material capable of providing selective heat and pressure to the lamination assembly 100. Second platen 810 may be manipulated or otherwise moved to provide a variable force on the lamination assembly 100 such that the adhesive layer 105 is melted and a material flow 500 is initiated sufficient to urge entrained gas bubbles 503 in a direction in which they may be removed from the lamination assembly 100. The amount of pressure, including the total pressure and the pressure as varied, may be adjusted for different lamination assemblies 100, as desired.

To produce a lamination 300, platen 810 provides substantially uniform heat to the second rigid substrate 107. As shown in FIG. 9, the second platen 810 is brought into contact or otherwise adjacent to the second rigid substrate 107. Second platen 810 is heated to a temperature greater than the melting point of adhesive in the adhesive layer 105. The adhesive layer 105 is thereby heated to a temperature greater than the melting point of the adhesive therein.

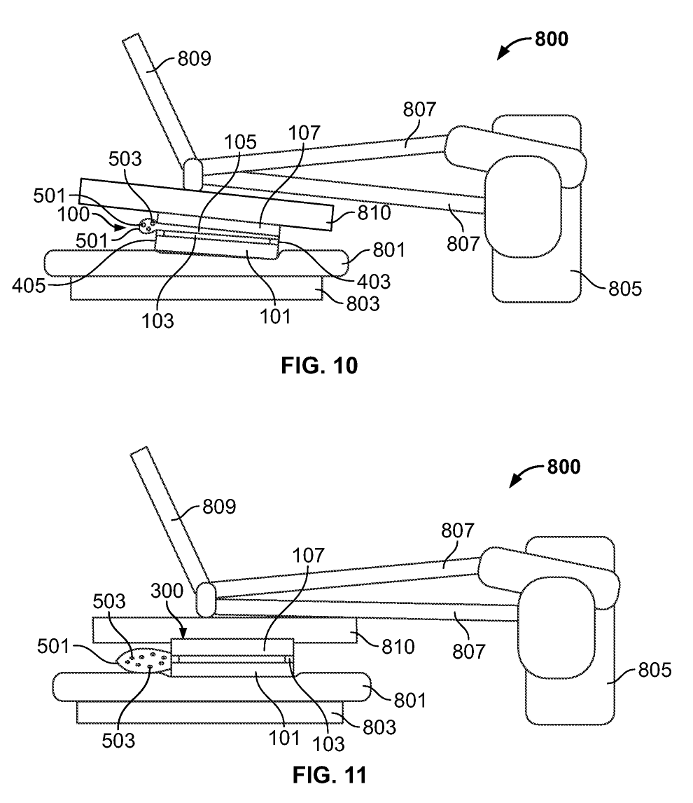

As shown in FIG. 10, as the adhesive layer 105 begins to melt, the second rigid substrate 107 moves in a direction toward the first rigid substrate 101 at the first end 403, creating a material flow urging the adhesive to flow in a direction toward the second end 405. As the flow continues, excess adhesive 501 is expelled from the lamination assembly 100 wherein entrained gas bubbles 503 are likewise expelled from lamination assembly 100. The pressure applied by second platen 810 is adjusted in a manner to continue the material flow of adhesive in a direction toward the second end 405.

The pressure applied by second platen 810 is increased to a greater pressure, wherein the pressure across the second rigid substrate 107 is substantially uniform, as shown in FIG. 11. The apparatus 800 and lamination assembly 100 is then permitted to cool or is externally cooled by any known method to form a lamination 300. The excess adhesive 501, including the entrained gas bubbles 503, is removed by cutting, scraping or otherwise removing the material. The formed lamination 300 includes an adhesive layer 105 substantially free of entrained gas bubbles. Although FIG. 11 is shown with a lamination assembly 100 having an optional perimeter step 103, the apparatus 800 may be utilized to join rigid substrates with an adhesive layer 105 therebetween. In addition, the apparatus 800 is not limited to the configuration shown and may include any arrangement of apparatus that provides heat and pressure to the lamination assembly to provide the material flow of adhesive.

### EXAMPLES

The following examples illustrate non-limiting methods for producing gas bubble-free rigid to rigid laminations using embodiments according to the disclosure. The specific hot melt adhesive compositions disclosed do not limit scope of this disclosure and are merely exemplary of the types of adhesives that may be used. Further wide variation in thickness of the adhesive films and defects in the adhesive films prior to lamination of the substrates may be used.

### Example 1

ELVAX® 40W available from DuPont was modified with plasticizer to produce a clear tacky hot melt adhesive that would have the ability to easily flow at 80° C. to 100° C. ELVAX® is a federally registered trademark of E. I. Du Pont de Nemours and Company, Wilmington, Del. for synthetic resin. This material was coated in molten state using a laboratory hot melt coater equipped with heated metal bars onto siliconized release liner to obtain an adhesive film that varied in thickness from 250 to 325 microns (0.010″-0.013″) cross web and down web. The adhesive film was placed onto a 3″×2″ glass microscope slide and trimmed to the size of the slide using a razor knife. The siliconized release liner was removed and a second glass microscope slide was placed on top of the adhesive layer. Air bubbles were present in the adhesive film and air was obviously trapped between the adhesive layer and the glass slides. The stack was placed between siliconized release liners and the sandwich was placed on the foam pad base of a model HT400 clamshell type press, available from HIX Corporation, Pittsburg, Kans., and the top platen, heated to 90° C., was lowered onto the sandwich applying non-uniform low pressure. The configuration of the press is such that non-uniform pressure from the back to the front of the press is initially applied due to the clam shell design. Pressure was increased over time, gradually resulting in uniform pressure being applied over the surface of the sample due to the foam pad base. During the pressing operation, the a hot melt adhesive film flowed under the heat and pressure of the operation and the air bubbles entrapped between the two glass slides were excluded producing a visibly gas bubble free glass to glass lamination.

### Example 2

A glass microscope slide was modified to have a 300 micron (0.012 inch) high perimeter step built up on the surface of the slide by applying 3 layers of 100 micron (0.004 inch) thick 12.5 millimeter (½ inch) wide aluminum foil coated on one side with pressure sensitive adhesive parallel to each edge of the slide. A portion of the adhesive film from Example 1 was cut to approximately the size of the cavity formed by the aluminum foil perimeter strips and laid onto the glass in the cavity area. Air bubbles were present between the adhesive layer and the glass slide as well as in the adhesive layer. Further, the adhesive layer was non-uniform with respect to the dimensions of the cavity. The siliconized release liner was removed and two additional adhesive layers were laid over the top of the core adhesive layer and aluminum foil strips extending past the dimensions of glass slide. The silicone release liner was removed after each successive adhesive layer was applied. The overall adhesive stack had a plurality of air bubble defects and the adhesive application was non-uniform. The adhesive extending beyond the perimeter of the glass slide was trimmed with a razor knife and a second glass slide was placed on top of the adhesive layer. The lamination assembly was placed between two layers of siliconized release liner and pressed using the model HT400 tee shirt press as in Example 1. The resultant rigid to rigid lamination was substantially free of defects due to air entrapment and possessed optical properties that did not cause any observable image distortion when images were viewed through the filled cavity area of the laminated structure.

### Example 3

BASF Corporation UV curable hot melt polymer acResin™ 258 UV available from BASF, Ludwigshafen, Germany, which contains ˜5% acrylic acid was partially ionomerized in the melt state by partially neutralizing the acrylic acid portion of the acResin™ 258 to produce a tacky pressure sensitive adhesive film that resists flow at room temperature using the following procedure: 98.5 grams of BASF acResin™ 258 was heated to 120+ C. and stirred using a stainless steel propeller type mixing blade in an open vessel in a dark environment. To this, 7.4 grams of 2.2 molar potassium hydroxide solution in water was added drop wise to the heated acResin™ 258 while mixing over a period of 3 hours, maintaining temperature to permit the water carrying the potassium hydroxide and water formed from the reaction of the potassium hydroxide and acrylic acid to evaporate. The resultant pressure sensitive adhesive was clear having an ionomer content of ˜1.2% (˜24% of the acrylic acid was neutralized). The partially ionomerized adhesive was coated using the hot melt coater described in Example 1, producing a tacky pressure sensitive adhesive film with good cold flow resistance at room temperature. The adhesive film containing many bubbles was pressed between two glass microscope slides as described in Example 1 with the platen reduced to 80° C., the temperature at which liquid crystal displays are expected to survive when tested for environmental stability. After pressing, an optically clear rigid to rigid lamination was produced. The adhesive film was cured using a Fusion system “D” bulb and the cured film resisted adhesive flow at 120° C.

### Example 4

BASF corporations UV curable hot melt polymer acResin™ 258 which contains approximately 5% acrylic acid was partially ionomerized with potassium hydroxide solution to ˜57% of theoretical then modified with urethane acrylate oligomer and UV photoinitator to produce a compounded adhesive with better pre-UV cure hot flow properties using the following procedure: 100.99 grams of BASF acResin™ 258 was heated to 120° C. and stirred in an open vessel in a dark environment using a stainless steel propeller type mixing blade. 17.55 grams of 2.2 molar potassium hydroxide solution was added drop wise over a three hour period while the acResin™ was being stirred. Temperature was maintained at 120° C. to permit the water carrying the potassium hydroxide and water formed by the reaction of the potassium hydroxide with the acrylic acid to evaporate. The reaction product at 2.85% ionomer content was clear, tacky and exhibited good cold flow resistance at room temperature. The temperature of the reaction product was reduced to 100° C. 10.62 grams of BR 3731 available from Bomar Industries, Winsted, Conn. and 1 gram of Irgacure 1700 (Ciba Specialty Chemicals, Basel, Switzerland) was added to the reaction product while stirring. The hot melt mixture was mixed until uniformly blended then coated onto release liner using the hot melt coater described in Example 1. A second release liner was laid onto the adhesive surface. The coated pressure sensitive adhesive film was protected from light by enclosing the coated samples in an opaque carrier. Adhesive films with thickness variation of ˜25 microns cross web and down web, as well as containing many air bubbles, were produced all exhibiting good cold flow resistance at room temperature. A sample of adhesive film 400 to 425 microns thick was irradiated with UV light by passing the adhesive layer between release liners 4 times at 10 feet per minute under a Fusion Systems “D” bulb. The cured adhesive resisted flow at 115° C. while the un-cured sample flowed easily at this temperature. A glass slide construction with a 300 micron perimeter step was built as described in Example 2 and 2 layers of adhesive film 325 to 350 microns thick were used to cover the glass slide with the perimeter step. One layer of adhesive film was placed inside the perimeter formed by the aluminum foil layers after removal of one of the release liners. The second release liner was removed and one layer of adhesive was placed overall after removal of one of the release liners. No special care was taken to exclude air, and the sample had many air bubbles entrapped in the adhesive films, between the first layer of adhesive and the glass slide and between the first and second layer of adhesive. The second release liner was removed from the second adhesive layer and a second glass slide was placed on top of the adhesive layer. The construction was pressed using the model HT-400 press as in Example 1 with the heated platen set to 80° C. After pressing, an optically clear defect free lamination was produced. The laminated structure was irradiated with UV light by passing the structure 4 times under a Fusion Systems “D” bulb at 10 feet per minute. The exposed sample was suspended at a 45° angle in an 80° C. and held at temperature to determine if the adhesive cured sufficiently to resist this temperature. No movement of the glass slides was observed, indicating the adhesive had cured sufficiently to resist the 80° C. temperature requirement for liquid crystal display applications.

### Example 5

The manufacturing process for toughened liquid displays may include the ability to rework the displays should defects become introduced during manufacture or damage to the displays encountered while in use. Therefore adhesive systems are preferably such that the finished products can be de-bonded during manufacture and after they have been put into service. The following adhesive system was prepared and used to produce a construction with a 300 micron perimeter step and the ability to de-bond the display was tested.

BASF Corporation's acResin™ 3583 was modified with solid plasticizers to produce a tacky hot melt adhesive with acceptable cold flow resistance at room temperature using the following procedure: 77.5 grams of acResin™ 3583, 35.8 grams of Uniplex™ 280 CG available from Unitex Chemical Corp., Greensboro, N.C. and 11.9 grams of Uniplex™ 260 available from Unitex Chemical Corporation were mixed at 120° C. in an open vessel in a dark environment until uniformly blended. Foam generated during the mixing process was eliminated under vacuum prior to coating the adhesive. The viscosity of the adhesive at 80° C. was 400,000 cP. The resultant adhesive was coated on release liner, as in Example 1, to obtain a 325 to 350 micron adhesive layer and a second release liner was laid on top of the adhesive. Air bubbles were present in the adhesive film due to the coating method employed. The sample was used to prepare a laminated rigid to rigid structure as in Example 4. Once the structure was prepared, the sample was reheated to 80° C. prior to UV cure, and the surfaces could be separated while at temperature. After cure, UV cure separation of the two layers was extremely difficult, but could still be accomplished.

### Comparative Example 5 B

Melt flowability was tested with respect to viscosity of the adhesive film. A low viscosity modification of Example 5 was prepared and evaluated. 62.5 grams of acResin™ DS 3583 was blended with 40 grams of glycerol tri-benzoate and mixed using a stainless steel mixing blade at 120° C. in a dark environment until uniformly blended. The resultant viscosity was 37,500 cP at 80° C. The adhesive mixture was coated on a release liner as in Example 1. The coated adhesive film was very tacky and gummy in nature, exhibiting poor cold flow resistance at room temperature. Due to the tackiness and gumminess, thickness could not be measured accurately. The adhesive film was used to prepare a laminated rigid to rigid structure as in Example 4. The adhesive film flowed under heat and pressure; however, air was not expelled from the lamination as with higher viscosity adhesive films.

### Example 6

The use of a removable pressure sensitive adhesive layer to facilitate after cure ease of separation was tested by providing a 300 micron perimeter step slide prepared as in Example 2. An optically transparent removable pressure sensitive adhesive was laminated to the base inside the perimeter step and 2 layers of the adhesive from Example 5 was laid on top of the removable adhesive layer. A glass slide was placed on top of the structure and the sample was pressed at 80° C., as in Example 5. After pressing, the melt flow displaced air entrapped as it did in the experiments performed when not using the removable adhesive layer. The sample was cured using a Fusion System “D” bulb. The sample was heated and the glass slides could be separated with much less difficulty than exhibited in Example 5. The removable adhesive separated from the base layer, and the ease of separation was considered acceptable from an effort standpoint. This experiment confirmed that the melt flow and fill concept could be combined with conventional pressure sensitive adhesive layers for producing rigid to rigid laminations.

### Example 7

Larger format displays were prepared. 12 inch diagonal 4:3 length to width ratio ⅛ inch thick glass plates were prepared with ⅜ inch wide perimeter strips to achieve 200 micron, 300 micron and 400 micron high perimeter steps using pressure sensitive adhesive backed aluminum foil as in Example 2. The removable pressure sensitive adhesive from Example 6 and the 300 to 350 micron thickness hot melt adhesive films from Example 5 were used to construct simulated displays laminating the removable adhesive inside the perimeter in the cavity. Two layers of the adhesive film from Example 5 were then placed over top of the removable adhesive. No particular care was taken to exclude air from the interface of the melt layers, and some areas were present that contained no melt flow and fill adhesive. Glass plates of equal surface area to the base plates were placed on top of the exposed adhesive layer. The top glass plates used to cover the base plates with the 200 and 400 micron high perimeter strips were ⅛ inch thick, while the top plate for the 300 micron high perimeter strip sample was 1/16 inch thick. The structures were pressed individually at 80° C. using the model HT-400 press as described in Example 1. The melt flow and fill adhesive filled the cavities to produce laminated structures considered acceptable for optical display applications. To determine if environmental resistance properties could be achieved in large format applications the construction prepared with the 300 micron step was irradiated using a Fusion Systems “D” bulb. The sample was passed under the UV source 20 times at 10.6 feet per minute. The structure was hung vertically in an 80° C. temperature environment such that the front glass panel was free to move. No movement was observed after 200 hours exposure and no defects were generated. The sample was then placed in a negative 30° C. environment for 200 hours and no defects were generated. Additionally the sample was exposed to a 40° C./90% relative humidity environment for 200 hours with no defect generation.

The examples demonstrate that optical quality rigid to rigid constructions with good environmental resistance can be prepared in small and large format with tacky adhesive layers and simple lamination equipment using heat and pressure to provide material flow. Little care needs to be taken to control adhesive film thickness and air entrained in the adhesive films when they are produced. The concept can be used to produce rigid to rigid laminations where the rigid substrates are aligned such that there is no cavity between the rigid substrates, such as laminating a rigid substrate directly onto the face of a liquid crystal display. The work performed also shows that this concept can be used to produce optical quality rigid to rigid laminations in instances where the rigid substrates are separated by a cavity, which cavity needing to be filled. A rigid substrate, such as the face of a liquid crystal display, which may be surrounded by a perimeter bezel. In addition, the rigid top substrate of the display may be attached to the surface of the rigid bezel and the rigid face of the display screen with adhesive filling the cavity between the top substrate and the display face.

The adhesive mass utilized to produce optical quality laminations using the melt flow and fill concept is substantially greater than that required to produce laminated structures and fill cavities. This additional mass assists in the generation of the material flow required to expel gas bubbles during the lamination process. In one embodiment, greater than about twice the mass required to fill the area between the rigid substrates. Typically, up to 100% of the adhesive trimmed from around the perimeter of the pre and post laminated structures is capable of being recycled into another batch of adhesive of the same composition.

Those skilled in the art will immediately recognize that the use of the melt flow and fill concept could also be used with the highly sophisticated lamination equipment currently in use in the industry for lamination of rigid to rigid substrates for display applications, if desired.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for fabricating a rigid lamination comprising:
providing a first rigid substrate;
disposing an adhesive on a surface of the first rigid substrate;
disposing a second rigid substrate on at least a portion of the adhesive, the second rigid substrate having a first end and a second end;
heating the second rigid substrate to a substantially uniform temperature, the temperature being sufficient to melt the adhesive;
applying a non-uniform pressure to a surface of the second rigid substrate, the non-uniform pressure including a lesser pressure and a greater pressure, the greater pressure being applied at the first end of the second rigid substrate and being sufficient to impart adhesive flow in a direction toward the second end;
controllably increasing the pressure along at least a portion of the surface between the first end and the second end, the pressure increase being controlled to drive the adhesive flow in the direction toward the second end until the pressure applied is substantially uniform across the surface and the adhesive between the first rigid substrate and the second rigid substrate is substantially free of entrained gas bubbles; and
cooling the adhesive to form a rigid lamination having adhesive substantially free of entrained gas bubbles.

2. The method of claim 1, further comprising removing excess adhesive from the lamination, the excess adhesive containing entrained gas bubbles.

3. The method of claim 1, wherein a perimeter step is applied to the first rigid substrate and at least a portion of the adhesive is disposed within the perimeter step.

4. The method of claim 1, wherein the adhesive comprises a plurality of layers.

5. The method of claim 4, wherein at least one of the plurality of layers is a release layer.

6. The method of claim 5, wherein at least one of the plurality of layers is a pressure sensitive adhesive.

7. The method of claim 1, wherein the adhesive layer is subsequently cured.

8. The method of claim 7, wherein the adhesive layer is exposed to visible light to cure at least a portion of the adhesive layer.

9. The method of claim 7, wherein the adhesive layer is exposed to ultraviolet wavelength radiation to cure at least a portion of the adhesive layer.

10. The method of claim 7, wherein the adhesive layer is tacky after curing.

11. The method of claim 7, wherein the adhesive layer is tack free after curing.

12. The method of claim 1, wherein the adhesive layer comprises an ionomeric adhesive.

13. The method of claim 1, wherein adhesive layer has sufficient volume to create a material flow to expel entrained gas bubbles air in the adhesive layer subsequent to application of non-uniform pressure.

14. The method of claim 1, wherein the adhesive layer includes at least twice the mass required to fill an area between the first rigid substrate and the second rigid substrate.

15. The method of claim 1, wherein the viscosity of the adhesive layer is greater than about 37,500 cP at the substantially uniform temperature.

16. The method of claim 1, wherein the viscosity of the adhesive layer is greater than about 50,000 cP at the substantially uniform temperature.

17. An apparatus for forming a rigid lamination comprising:
a first platen arranged and disposed to receive a lamination assembly, the lamination including a plurality of rigid substrates with an adhesive disposed between at least two of the rigid substrates;
a second platen operably disposed with respect to the first platen in order to apply a force and apply heat to the lamination assembly,
wherein the second platen is configured to heat a surface of the lamination assembly to a substantially uniform temperature, the temperature being sufficient to melt the adhesive; and to apply a non-uniform pressure to the surface of the lamination assembly, the non-uniform pressure including a lesser pressure and a greater pressure, the greater pressure being applied to a first end of the surface and being sufficient to impart adhesive flow in a direction toward a second end;
wherein the second platen is further capable of controllably increasing the pressure along at least a portion of the surface between the first end and the second end, the increase being controlled to continue adhesive flow in the direction toward the second end until the pressure applied is substantially uniform across the surface.

18. The apparatus of claim 17, wherein a perimeter step is applied to the first rigid substrate and at least a portion of the adhesive is disposed within the perimeter step.

19. The apparatus of claim 17, wherein adhesive layer has sufficient volume to create a material flow to expel entrained gas bubbles air in the adhesive layer subsequent to application of non-uniform pressure.

20. The apparatus of claim 17, wherein the adhesive layer includes at least twice the mass required to fill an area between the first rigid substrate and the second rigid substrate.

21. A rigid lamination comprising:
a first rigid substrate having an adhesive disposed on at least a portion of the surface of the first rigid substrate;
a second rigid substrate in contact with the adhesive; and
wherein the adhesive includes a first portion and a second portion, the first portion being substantially free of entrained bubbles of gas and the second portion being removable and including entrained bubbles of gas.

22. The lamination of claim 21, wherein the rigid substrates are substantially aligned.

23. The lamination of claim 21, wherein the rigid substrates include an internal cavity.

24. The lamination of claim 21, wherein the internal cavity is bound by a perimeter step.

25. The lamination of claim 21, wherein the second portion is recyclable.

26. The lamination of claim 21, wherein the adhesive layer is cured.

27. The lamination of claim 26, wherein the adhesive layer is tacky after curing.

28. The lamination of claim 26, wherein the adhesive layer is tack free after curing.
